(19) United States
(12) Patent Application Publication
(10) Pub. No.: US 2008/0134167 A1
(43) Pub. Date: Jun. 5, 2008

(54) Method for Representing Description Language and Data Structure to Update Pump Tool, Ipmp Tool Updating Method and Client Apparatus Using the Same

(76) Inventors: Jong Jin Chae, Kyungki-do (KR); Jae Hong Park, Seoul (KR); Je Ho Nam, Seoul (KR); Jae Gon Kim, Daejeon (KR); Jin Woo Hong, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/814,109

(22) PCT Filed: Jan. 17, 2006
(86) PCT No.: PCT/KR06/00177

§ 371 Date: Jul. 17, 2007

(30) Foreign Application Priority Data
Jan. 17, 2005 (KR) 10-2005-0004178
Nov. 24, 2005 (KR) 10-2005-0113143

(51) Int. Cl. G06F 9/44

(52) U.S. Cl. 717/173; 717/168

(57) ABSTRACT

The present invention relates to a language representation method and data structure for updating an IPMP tool, a method for updating an IPMP tool using the same and a client apparatus using the same in protection and management of multimedia contents, by which the IPMP tool can be represented dynamically in order to provide convenience to users. In the language representation method for updating an IPMP tool in an MPEG-21 multimedia framework, an update element, which describes update information of the IPMP tool, is defined as a higher level element; and a location element, which has information on a location allowing the IPMP tool to be carried thereto, is described as a lower level element of the update element.

### TECHNICAL FIELD

The present invention relates to a language representation method and data structure for updating an IPMP tool, a method for updating an IPMP tool using the same and a client apparatus using the same in protection and management of multimedia contents, by which the IPMP tool can be represented dynamically in order to provide convenience to users.

### BACKGROUND ART

Rapid development of Internet environment and the arrival of high speed and wideband network environment have led to the popularization of multimedia contents. In addition, various studies have been being made on Digital Right Management (DRM) in order to illegal duplication and unfair use of multimedia contents. Such approaches are gradually enclosing digital watermarking, encoding and so on in order to satisfy consumers, writers and distributors within the life cycle of multimedia contents.

As such an approach, the Intellectual Property Management and Protection (IPMP) functions as an element of an MPEG-21 framework to protect and manage copyright on Digital Item (DI) in MPEG standards.

Korean Patent Application Serial No. 2004-0051789 entitled “Language Representation Method for Protection and Management of Multimedia Contents”, commonly assigned with this application, relates to a language representation method for such IPMP. This document proposes a language representation method capable of providing systematic protection for the copyright and protection and management for sources throughout the entire life cycle of digital multimedia contents including creation, consumption, expiration and so on.

Furthermore, Korean Patent Application Serial No. 2004-0089440 entitled “Language Representation Method for Contents Delivery in Multimedia Framework” proposes a language representation method that includes communication regulations for message transmission between peers in an MPEG-21 multimedia framework and represents a delivery scheme for protected and unprotected contents.

However, the above-proposed IPMP language representation methods represent a tool in a sort of static fashion. That is, the tool is represented according to a method that is needed from creation to consumption steps among the entire life cycle of the digital item including creation, consumption and expiration. However, actual consumption of a digital item frequently needs to represent the tool in a dynamic fashion rather than the static fashion. In these cases, it is difficult to represent the tool according to the above-proposed methods.

For example, when authority is given in the broadcast environment, a Conditional Access System (CAS) enabling services and so on has to newly update specific tool information according to time or program in order to protect copyright. That is, when a broadcast service subscriber requests service from a broadcast service provider in order to watch a specific program, the broadcast service provider delivers new information necessary for watching a requested program to the broadcast service subscriber, typically by using Entitlement Management Message (EMM) and Entitlement Control Message (ECM) so that the broadcast service subscriber can watch the requested program based upon new information provided. In particular, in the CAS broadcast environment, information necessary for protection and management of digital contents are updated at a predetermined time period, and necessary information is provided at user request.

In addition, if a digital item having copyright is not completely consumed as occasion demands, a consumer may consume the digital item based upon his/her true right even after a predetermined time has passed. However, it is usual that most programs and systems are periodically or aperiodically updated so that sometimes the remaining digital item may not be consumed according to application program, OS environment or H/W capability of a possessed station.

In the above-mentioned two cases, it is required to carry out IPMP language representation in a dynamic process instead of the conventional static processes, such that new information can be added.

### DISCLOSURE OF INVENTION

### Technical Problem

The present invention has been made to solve the foregoing problems of the prior art and it is therefore an object of the present invention to provide a language representation method and data structure for updating an IPMP tool, a method for updating an IPMP tool using the same and a client apparatus using the same in protection and management of multimedia contents, by which the IPMP tool can be represented dynamically in order to provide convenience to users.

### Technical Solution

In order to realize the above object, the invention provides a language representation method for updating an IPMP tool in an MPEG-21 multimedia framework, the method comprising steps of:

defining an update element, which describes update information of the IPMP tool, as a higher level element; and
describing a location element as a lower level element of the update element, the location element having information on a location allowing the IPMP tool to be carried thereto.

In order to realize the above object, the invention also provides a language representation method for updating an IPMP tool in an MPEG-21 multimedia framework, the method comprising steps of:

(a) parsing configuration setting elements of the IPMP tool;

(b) if an update element exists in the configuration setting elements, parsing and registering the update element and a location element of a remote tool server peer for updating the IPMP tool; and

(c) updating the IPMP tool by downloading an IPMP tool to be used in updating and IPMP tool information related therewith from the tool server peer.

In order to realize the above object, the invention also provides a data structure for updating an IPMP tool in an MPEG-21 multimedia framework, comprising: an update element, which describes update information of the IPMP tool, as a higher level element; and a location element as a lower level element of the update element, describing information of a location allowing the IPMP tool to be carried thereto.

Furthermore, in order to realize the above object, the invention provides a client apparatus comprising: a memory storing an Intellectual Property Management and Protection (IPMP) tool and update information of the IPMP tool; an update information register for parsing an update element existing in a multimedia framework and a location element of a remote tool server for updating the IPMP tool, the location element being a lower level element of the update element, to register as update information in the memory; an update controller for sending an update request for the IPMP tool to a remote tool server, in response to the update request for the IPMP tool, as indicated by the location element registered in the memory, comparing an IPMP tool and tool information received from the remote tool server with the existing IPMP tool stored in the memory to check validity, and if the IPMP tool received from the remote tool server is valid, storing the received IPMP tool and tool information in the memory; and a transceiver for communicating with the remote tool server at an indicated location, under the control of the update controller, to deliver the update request and receive the IPMP tool and tool information in response to the update request.

According to the present invention as described hereinbefore, a client apparatus using digital items protected by IPMP can utilize a method and data structure for updating an IPMP tool of the invention in order to effectively update the IPMP tool.

While the present invention has been described with reference to the particular illustrative embodiments and the accompanying drawings, it is not to be limited thereto but will be defined by the appended claims. It is to be appreciated that those skilled in the art can substitute, change or modify the embodiments into various forms without departing from the scope and spirit of the present invention.

### Advantageous Effects

Furthermore, this invention proposes a novel concept in IPMP tool update, such that an IPMP tool can be updated automatically or manually by using an update schema technique of the invention when a digital item is consumed in an MPEG-21 peer. This provides dynamic tool representation in contrast with static representation, thereby enabling inter-operable tool management. Moreover, the update process can be carried out after the present status of the IPMP tool is checked instead of being carried out constantly, thereby enabling conditional update.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an XML structure diagram illustrating a language representation method of the invention;

FIG. 2 is a diagram illustrating a process of updating an IPMP tool according to an embodiment of the invention;

FIG. 3 is a flowchart illustrating a detailed process of updating an IPMP tool in a peer according to an embodiment of the invention; and

FIG. 4 is a functional block diagram illustrating the construction of a client apparatus to which the invention is applied.

### BEST MODE FOR CARRYING OUT THE INVENTION

A preferred embodiment of the present invention will now be described in detail with reference to the accompanying drawings. It should be construed that the same reference numbers and signs are used to designate the same or similar components throughout the accompanying drawings. In the following description of the invention, well-known functions or constructions will not be described in detail since they would unnecessarily obscure the understanding of the invention.

Dynamic representation of an IPMP tool may have important factors such as location of necessary information, reliability of the location and the manner for carrying the necessary information from the location.

In these factors, an IPMP information element about the location where an IPMP tool can be obtained is described in a tool element (ipmpinfo:Tool) of an information element (IPMPInfo) as disclosed by Korean Patent Application Serial No. 2004-0089440 entitled “Language Representation Method for Contents Delivery in Multimedia Framework”, assigned commonly with the application. However, this is a different matter from whether or not the location represented in this document is a site allowing tool information to be updated. Trust Mirror site, 3rd party and so on are totally different locations, and especially, capability of notifying reliable location information is required.

In addition, some update conditions are required in order to update the IPMP tool. For example, the IPMP tool may be updated periodically or updated according to Operating System or station conditions from an IPMP tool provider. Such condition information for update can give a clue to find a missing tool processed in an MPEG-4 IPMPX.

Furthermore, enabling update in response to necessity is a sort of inter-operable tool management function. Unconditional update is senseless but update should be carried out from a site reliable through tool provider's demand and validity date.

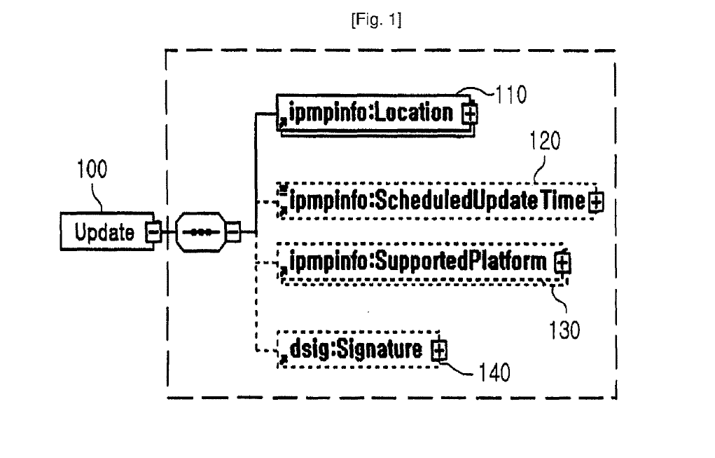

FIG. 1 is an XML structure diagram illustrating a language representation method of the invention.

Now the language representation method for updating an IPMP tool proposed in consideration of the above-mentioned conditions will be described with reference to FIG. 1.

Referring to FIG. 1, the present invention provides an update element 100 in order to represent update information of an IPMP tool in an MPEG-21 multimedia framework. The update element 100 is described as a top level but not as a specific namespace. The update element 100 is not limited by other specific elements such as IPMP, IPMPINFO and DID or DID_IPMP standard.

The update element 100 represents the update information of the IPMP tool, and is of a data structure having Location (i.e., location element) 110 for sequence connection, Scheduled Update Time (i.e., scheduled update time element) 120, Supported Platform (i.e., supported platform element) 130 and Signature (i.e., signature element) 140.

The IPMP tool can be updated automatically (e.g., by schedule) or manually. When the IPMP tool is updated, related information in a peer, that is, related IPMP tool information parsed by an IPMP information descriptor should be also updated.

The following construction shows an example of the update element 100.

<element name=“Update” type=“ipmpinfo:UpdateType”/>
<complexType name=“UpdateType”>

<sequence>

<element ref=“ipmpinfo:Location”
maxOccurs=“unbounded”/>
<element ref=“ipmpinfo:ScheduleUpdateTime”
minOccurs=“0”/>
<element ref=“ipmpinfo:SupportedPlatform”
minOccurs=“0”

maxOccurs=“unbounded”/>

<element ref=“dsig:Signature”minOccurs=“0”/>

</sequence>

</complexType>

The Location 110 as a lower level element of the update element 100 includes information on remote location where the IPMP tool can be brought for the purpose of updating. The location for updating may be different from the position, which the IPMP tool was referred to in the past, or may be identical with the location of a remote element having description on the remote location where the IPMP tool can be brought. The reference location about the Location 110 can have any Uniform Resource Identifier (URI) value.

For example, the Location 110 may describe TrustLocation and Location. The TrustLocation describes location information trusted by a tool provider so that automatic tool updating can be processed without through additional approval. The Location describes general location information for updating, and location information described in the Location corresponds to information given to a general tool rather than a tool trusted between MPEG-21 peers.

The following construction shows an example of the Location 110.

<element name=“Location” type=“ipmpinfo:RemoteType”/>

The Scheduled Update Time 120 includes date and time, and describes time condition when the scheduled update of the IPMP tool is started. For example, it can be constructed that IPMP tool update can be started when the present date is later than the Scheduled Update Time 120. The Scheduled Update Time 120 is generally related with the life cycle of the tool that depends on time information, and may not be described if necessary. The Scheduled Update Time 120 may selectively have one of Period Of Circulation information and Periodic information. The Period Of Circulation information describes period or interval of proper operation of the IPMP tool, and the Periodic information describes update cycle information of the IPMP tool, in which generally interval is not fixed. As described above, the Period Of Circulation information and the Periodic information are extensible child elements.

The following construction shows an example of the Scheduled Update Time 120.

<element name=“ScheduledUpdateTime”

type=“ipmpinfo:ScheduledUpdateTimeType”/>

<complexType name=“ScheduledUpdateTimeType”>

<simpleContent>

<extension base=“dateTime”>

<attribute name=“periodic” type=“duration”
use=“optional”/>

</extension>

</simpleContent>

</complexType>

In this illustrative construction, the Scheduled Update Time 120 has Periodic information, and time is represented as duration.

The Supported Platform 130 describes a condition that defines the required platform properties and capabilities necessary for supporting the IPMP tool such as hardware, middleware or operating system. In this case, if the present properties and capabilities of the IPMP peer do not satisfy the information described in the Supported Platform 130, IPMP tool update should be started.

The Supported Platform 130 describes information that is supported, designated or determined by an IPMP provider, and may not be described if necessary. The Supported Platform 130 may include for example Tool Version, Operating System and Peer. The Tool Version describes version information of the IPMP tool, in which a certificate allowing tool execution is defined, then the OS element describes environment information where the IPMP tool can be operated in a specific operating system, and the last peer describes hardware capability information of an MPEG-21 station. All of the afore-mentioned elements of the Supported Platform 130 are extensible elements.

The following construction shows an example of the Supported Platform 130.

<element name=“SupportedPlatform”
type=“ipmpinfo:SupportedPlatformType”/>
<complexType name=“SupportedPlatformType”>

<sequence>

<any anmespace=“##any” processContents=“lax”
minOccurs=“0”/>

<sequence>

</complexType>

The Signature 140 includes a signature about the update element 100 or the Location 110.

The following construction shows an example of the Signature 140.

<element ref=“dsig:Signature” minOccurs=“0”/>

The following construction shows an example described according to the foregoing description. The following construction indicates that “scheduled updating” of the IPMP tool is started from Jan. 1, 2005 with a period of one day. According to another construction, the IPMP tool may be updated when the IPMP tool fails to support station platform specification described by mpeg4ipmp schema.

<ipmpinfo:Tool>

<ipmpinfo:ToolBaseDescription>

<ipmpinfo:IPMPToolID>urn:mpegRA:mpeg21:IPMP:ABC002:56:79</ipmpinfo:IPMPToolID>
<ipmpinfo:Remote ref=“urn:IPMPToolsServer:ToolPartEnc002-9090-v.1.0”/>
<ipmpinfo:ConfigurationSetings>

<ipmpinfo:Configuration>...</ipmpinfo:Configuration>
<ipmpinfo:Update>

<ipmpinfo:Location ref=“urn:IPMPToolsUpdatingSever1:ToolPartEnc002-9090-

NewVersion”/>

<ipmpinfo:ScheduledUpdateTime period=“PID”>2005-03-07T00:00:00
</ipmpinfo:ScheduledUpdateTime>

<ipmpinfo:SupportedPlatform xmlns:mpeg4ipmp=“urn:mpeg:mpeg4:IPMPSchema:2002”>

<mpeg4ipmp:TerminalID>

<mpeg4ipmp:TermimalType>

<mpeg4ipmp:Vendor>Samsung</mpeg4ipmp:Vendor>
<mpeg4ipmp:Model>Sens SP28-D130</mpeg4ipmp:Model>

</mpeg4ipmp:TerminalType>
<mpeg4ipmp:OperatingSystem>

<mpeg4ipmp:Vendor>Microsoft Corporation</mpeg4ipmp:Vendor>
<mpeg4ipmp:Model>Windows XP Professional</mpeg4ipmp:Model>
<mpeg4ipmp:Version>XP SP2</mpeg4ipmp:Version>

</mpeg4ipmp:OperatingSystem>
<mpeg4ipmp:CPU>

<mpeg4ipmp:Vendor>Intel Corporation</mpeg4ipmp:Vendor>
<mpeg4ipmp:Model>Intel ® Celeron ® M Processor</mpeg4ipmp:Model>
<mpeg4ipmp:Speed>100</mpeg4ipmp:Speed>

</mpeg4ipmp:CPU>
<mpeg4ipmp:Memory>

<mpeg4ipmp:Vendor>Samsung</mpeg4ipmp:Vendor>
<mpeg4ipmp:Model>DDR2 SDRAM</mpeg4ipmp:Model>
<mpeg4ipmp:Size>256</mpeg4ipmp:Size>
<mpeg4ipmp:Speed>800</mpeg4ipmp:Speed>

</mpeg4ipmp:Memory>

</mpeg4ipmp:TerminalID>

</ipmpinfo:SupportedPlatform>

</ipmpinfo:Update>

</ipmpinfo:ConfigurationSettings>

</ipmpinfo:ToolBaseDescription>

</ipmpinfo:Tool>

Generally, in IPMP description, the update element 100 constructed as above may be arranged in an element for describing Tool Information or an element for describing Configuration Setting in order to provide the update information of the tool.

In case of applying the update element 100 to the IPMP technology, updating may be processed as follows.

For example, assuming that a consumer possessed a specific digital item 5 years ago, IPMP tool information belonging to the specific digital item is composed of execution DLL files executed under Microsoft Windows 200 OS environment, and the consumer replaced his/her station with a new one having Windows XP OS, when the attempts to consume the specific digital item, he/she has difficulty in consuming the digital item even with consumption right since IPMP tool information necessary for execution does not match the current environment. If the update element 100 of the invention is included in the IPMP description construction of the specific digital item, it is possible to obtain IPMP tool status, tool version, operation environment, peer information, time information related with update condition and location information related with update information from the update element 100. Based upon this, tool update information of a corresponding location can be acquired and then the specific digital item can be consumed.

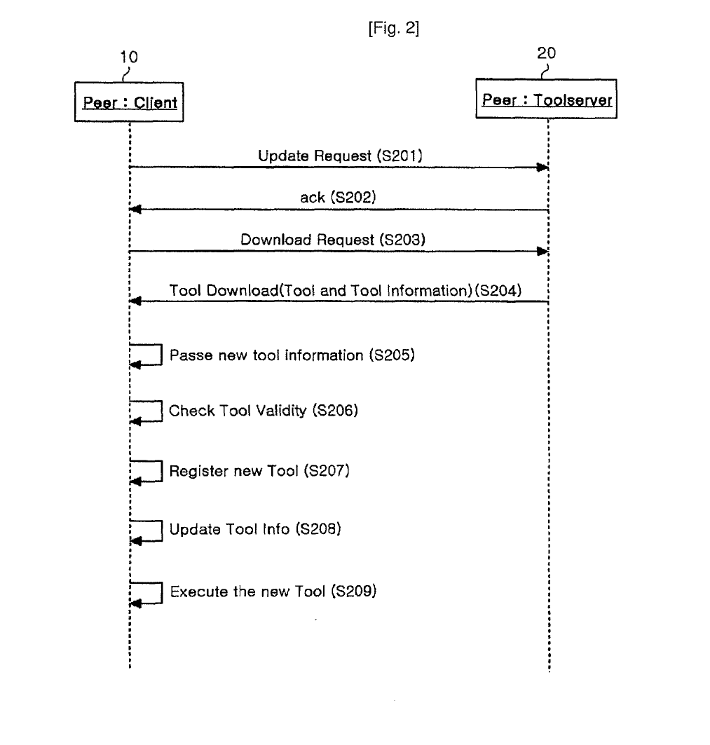

FIG. 2 is a diagram illustrating a process of updating an IPMP tool according to an embodiment of the invention.

Referring to FIG. 2, in a process for updating the IPMP tool in an MPEG-21 multimedia framework according to the invention, first in S201, a client peer (Peer:Clients) 10 sends an update request for the IPMP tool to a remote tool server peer (Peer:ToolServer) 20 in order to acquire the IPMP tool necessary for updating.

Then, in S202, the client peer 10 receives an acknowledgment from the tool server peer 20 in response to the update request, and in S203, sends a download request for the IPMP tool and tool information, which will be used in tool updating, to the tool server peer 20. The tool information may include for example tool ID, information on initialization, information on configuration settings and so on.

As a result of the download request, the client peer 10 receives the tool and tool information, which will be used in tool updating, downloaded from the tool server peer 20 in S204.

The client peer 10 parses the new tool information downloaded from the tool server peer 20 in S205, and checks tool validity on the IPMP tool in S206.

If the IPMP tool is valid as a result of the checking step, the client peer 10 registers the new IPMP tool in S207, and updates the tool information (Tool Info) in S208 so as to carry out the IPMP tool updating according to the invention.

The client peer 10 executes the updated, new tool information in S209 so that the latest IPMP tool can be applied.

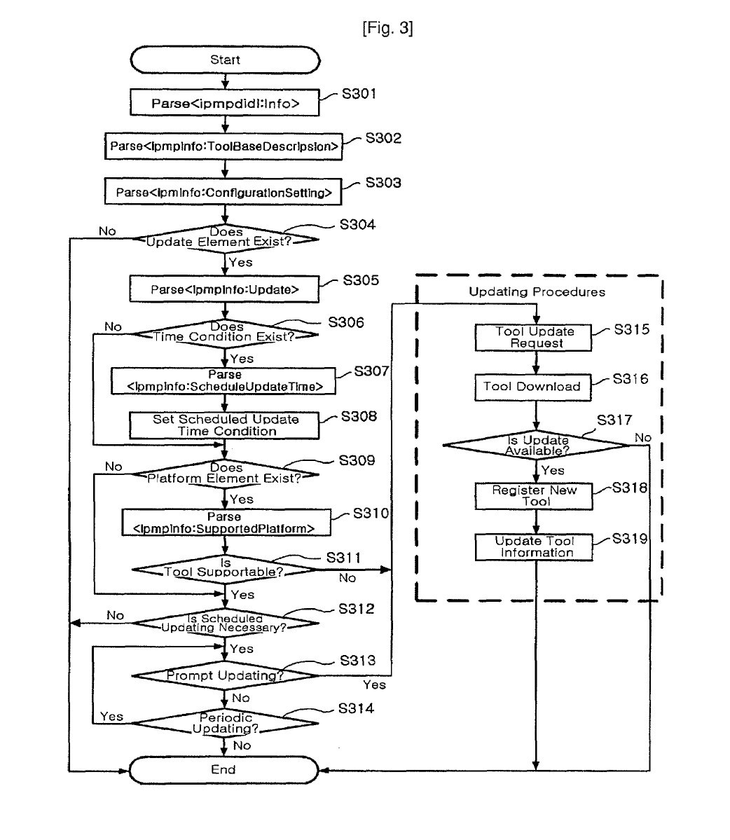

FIG. 3 is a flowchart illustrating a detailed process for updating an IPMP tool in a peer according to an embodiment of the invention.

The process for updating the IPMP tool according to the invention as shown in FIG. 3 is given to describe in more detail the process executed in the client peer 10 of FIG. 2.

Referring to FIG. 3, the client peer 10 parses IPMP Digital Item Declaration Language (DIDL) elements (Parse<ipmpdidl:Info>) in S301.

Then, the client peer 10 parses the tool information of the IPMP tool (Parse<ipmpinfo:ToolBaseDescription>) in S302, parses configuration setting elements (ConfigurationSettings) providing setting environment for a specific IPMP tool in S303, and then judges whether or not the configuration setting elements have an update element 100 (refer to FIG. 1) in S304.

If the configuration setting elements have the update element 100 as a result of S304, the update element 100 is parsed, and its Location 110 is parsed and registered as a reference to the remote tool server peer 20 for updating the IPMP tool (Parse<ipmpinfo:Update>) in S305.

Then, the client peer 10 judges whether or not time condition is established in the update element 100 in S306, in which the time condition corresponds to Scheduled Update Time 120 (refer to FIG. 1) that is described so that the IPMP tool can be updated at a predetermined time. If the time condition exists, the Scheduled Update Time 120 is parsed (Parse<ipmpinfo:ScheduledUpdateTime>) in S307, and the scheduled update time condition is set in the client peer 10 in S308.

Then, the client peer 10 judges whether or not Supported Platform 130 defining platform properties and capabilities necessary for properly supporting the IPMP tool exists in the update element 100 in S309. If the Supported Platform 130 exists, the Supported Platform 130 is parsed (Parse<ipmpinfo:SupportedPlatform>) in S310.

Based upon the parsed Supported Platform 130, it is judged whether or not the client peer 10 satisfies platform properties and capabilities, that is, tool conditions necessary for properly supporting the IPMP tool in S311. If the client peer 10 does not satisfy the platform properties and capabilities, updating the IPMP tool is executed in S315.

If the client peer 10 satisfies the platform properties and capabilities, as a next procedure, it is judged whether or not updating according to scheduled time is necessary in S312.

If scheduled update is judged necessary as a result of S312, the present time is compared with the scheduled update time condition to judge whether or not prompt update is necessary in S313.

If present update is judged necessary as a result of S313, the IPMP tool update is started in S315.

If it is judged that updating is necessary but not promptly as a result of S313, it is judged again whether or not periodic updating is necessary in S314.

If periodic updating is judged necessary as a result of S314, S133 is executed again to inspect time necessary for updating so that updating can be executed periodically. If periodic updating is not necessary as a result of S314, the process is terminated.

If updating the IPMP tool is judged necessary as a result of S311 and S313, the client peer 10 sends an IPMP tool update request to the tool server peer 20, which provides the IPMP tool and tool information to be used in updating, with reference to the Location 110 of lower level elements of the update element 100 in S315.

Then, as a result of the request, the client peer 10 receives an IPMP tool to be used in update and the IPMP tool information related with the IPMP tool, downloaded from the tool server 20 in S316.

The client peer 10 inspects the validity of the received IPMP tool in S317, if valid, registers the new IPMP tool in S318, and updates the IPMP tool information in S319 so as to update the IPMP tool according to the invention. That is, the client peer 10 parses the downloaded, new tool information and compares it with the existing tool information. If the downloaded tool is new, the new tool and related tool information are registered in the client peer 10, and thus the updating process of the invention is completed.

A data structure for updating the IPMP tool in an MPEG-21 multimedia framework and a method for updating the IPMP tool of the invention can be realized as codes written in a record medium in a manner readable by a computer. The computer-readable record medium includes all types of recording devices storing data that can be read by a computer system. Examples of the computer-readable record medium include ROM, RAM, CD-ROM, magnetic tape, floppy disk, optical data storage and so on. The computer-readable record medium may also include a recording device using for example carrier wave transmitted via Internet. Furthermore, the computer-readable record medium can store and be executed on codes that are distributed through computer systems connected via a network and readable by the computer systems in a distributed processing.

Furthermore, a client apparatus (corresponding to a client peer) using digital contents can update the IPMP tool by using the IPMP tool updating method of the invention.

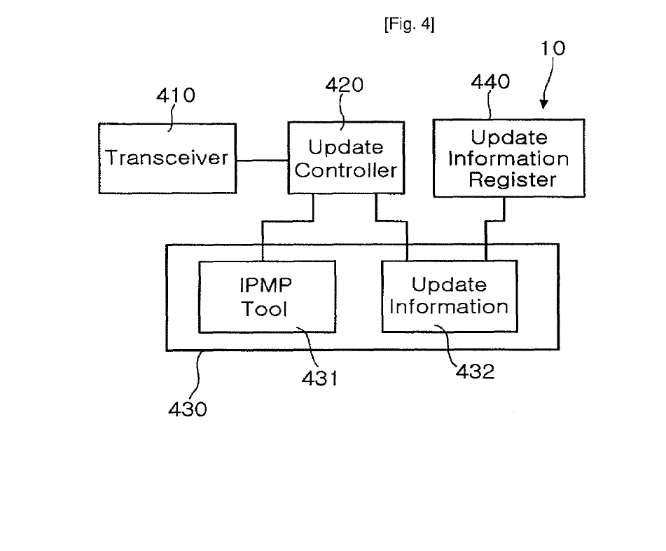

FIG. 4 is a functional block diagram illustrating the construction of a client apparatus to which the invention is applied.

Referring to FIG. 4, a client apparatus includes a transceiver 410, an update controller 420, a memory 430 and a register 440. The transceiver 410 serves to communicate with a remote tool server, delivering an update request thereto while receiving an IPMP tool and tool information in response to the update request therefrom. The update controller 420 sends the update request for the IPMP tool to the remote tool server, in response to the update request for the IPMP tool, as indicated by a location element stored in the memory 430, and checks the validity of the received IPMP tool, if received from the remote tool server in response to the IPMP tool and tool information, in order to update the received IPMP tool and tool information. The memory 430 stores the IPMP tool 431 updated by the update controller 420 and the update information 432 of the registered IPMP tool. The update information register 440 parses an update element existing in a multimedia framework and a location element of the remote tool server for updating the IPMP tool, existing as a lower level element of the update element, in order to registering the update element and the location element as update information in the memory 430.

The update information register 440 is means for parsing an update element in a multimedia framework to register update information, and the update element existing in the multimedia framework can have a data structure as shown in FIG. 1. Therefore, if the update element has Scheduled Update Time, which is described so that the IPMP tool can be updated at a predetermined time, the update information register 440 parses and registers the Scheduled Update Time in the update information. In addition, if the update element has Supported Platform that defines platform properties and capabilities necessary for supporting the IPMP, the update information register 440 also parses and registers the Supported Platform as the update information.

Accordingly, the update information stored in the memory 430 includes at least one of remote location information, update time information and supported platform information by which the IPMP tool can be updated.

The update controller 420 judges whether or not to execute updating with reference to conditions described in the update information 432, which is stored in the memory 430, if updating is judged necessary, sends an update request to the remote tool server positioned at a predetermined location. In this case, judgment whether or not to execute updating can be determined according to the update conditions registered in the update information 432. For example, if Scheduled Update Time exists in the update information 432, the update controller 420 judges that updating be necessary at a specific time designated by the Scheduled Update Time. In addition, if the Supported Platform exists in the update information 432, the update controller 420 compares whether or not the platform properties and capabilities of the station satisfy the conditions designated by the Supported Platform, and if the conditions are not satisfied, judges that updating be needed.

### INDUSTRIAL APPLICABILITY

Furthermore, this invention proposes a novel concept in IPMP tool update, such that an IPMP tool can be updated automatically or manually by using an update schema technique of the invention when a digital item is consumed in an MPEG-21 peer. This provides dynamic tool representation in contrast with static representation, thereby enabling inter-operable tool management. Moreover, the update process can be carried out after the present status of the IPMP tool is checked instead of being carried out constantly, thereby enabling conditional update.

1. A language representation method for updating an Intellectual Property Management and Protection (IPMP) tool in an MPEG-21 multimedia framework, the method comprising steps of:
defining an update element, which describes update information of the IPMP tool, as a higher level element; and
describing a location element as a lower level element of the update element, the location element having information on a location allowing the IPMP tool to be carried thereto.

2. The language representation method according to claim 1, further comprising step of: describing a scheduled update time element as a lower level element of the update element, the scheduled update time element having a time condition enabling the IPMP tool to be updated at a predetermined time.

3. The language representation method according to claim 1, further comprising step of: describing a supported platform element as a lower level element of the update element, the supported platform element having an update condition for defining platform properties and capabilities necessary for supporting the IPMP tool.

4. The language representation method according to claim 1, further comprising step of: describing a signature element having a signature about the update element as a lower level element of the update element.

5. The language representation method according to claim 1, wherein the update element is arranged in an element that describes tool information of a construction representing IPMP or an element that describes configuration settings.

6. The language representation method according to claim 2, wherein the scheduled updated time element selectively has period-of-circulation information describing a period or interval of a normal operation of the IPMP tool and periodic information describing update cycle information of the IPMP tool.

7. The language representation method according to claim 3, wherein the supported platform element has at least one selected from a group consisting of an IPMP tool version element describing IPMP tool version information, an operating system element describing environment information allowing the IPMP tool to operate and a peer element describing hardware capability information at the side of a client peer.

8. A language representation method for updating an Intellectual Property Management and Protection (IPMP) tool in an MPEG-21 multimedia framework, the method comprising steps of:
(a) parsing configuration setting elements of the IPMP tool;
(b) if an update element exists in the configuration setting elements, parsing and registering the update element and a location element of a remote tool server peer for updating the IPMP tool; and
(c) updating the IPMP tool by downloading an IPMP tool to be used in updating and IPMP tool information related therewith from the tool server peer.

9. The language representation method according to claim 8, wherein the step (b) comprises determining to update the IPMP tool at a predetermined time if the update element has a scheduled update time element, which has description allowing the IPMP tool to be updated at the predetermined time.

10. The language representation method according to claim 8, wherein the step (b) comprises determining to update the IPMP tool if the update element has a supported platform element defining platform properties and capabilities necessary for supporting the IPMP tool and the client peer does not satisfy the platform properties and capabilities.

11. The language representation method according to claim 8, wherein the step (c) comprises: by the client peer,
sending an update request to the tool server peer, which provides the IPMP tool to be used in updating and the tool information related therewith, with reference to a location element as a lower level element of the update element;
downloading the IPMP tool to be used in updating and the tool information related therewith from the tool server peer; and
checking whether or not the downloaded IPMP tool is valid, and if the downloaded IPMP tool is valid, registering the downloaded IPMP tool and updating tool information.

12. The language representation method according to claim 8, wherein the tool information includes at least one selected from a group consisting of tool ID, initialization related information and configuration setting related information.

13. A data structure for updating an Intellectual Property Management and Protection (IPMP) tool in an MPEG-21 multimedia framework, comprising:
an update element as a higher level element, describing update information of the IPMP tool; and
a location element, which describes information of a location allowing the IPMP tool to be carried thereto, as a lower level element of the update element.

14. The data structure according to claim 13, further comprising a scheduled update time element as a lower level element of the update element, the scheduled update time element having a time condition allowing the IPMP tool to be updated at a predetermined time.

15. The data structure according to claim 13, further comprising a supported platform element as a lower level element of the update element, the supported platform element having an update condition for defining platform properties and capabilities necessary for supporting the IPMP tool.

16. The data structure according to claim 13, further comprising a signature element having a signature about the update element as a lower level element of the update element.

17. The data structure according to claim 14, wherein the scheduled update time element selectively has a period-of-circulation information describing period or interval of a normal operation of the IPMP tool and periodic information describing update cycle information of the IPMP tool.

18. The data structure according to claim 15, wherein the supported platform element has at least one selected from a group consisting of an IPMP tool version element describing IPMP tool version information, an operating system element describing environment information allowing the IPMP tool to operate and a peer element describing hardware capability information at the side of a client peer.

19. A client apparatus comprising:
a memory storing an Intellectual Property Management and Protection (IPMP) tool and update information of the IPMP tool;
an update information register for parsing an update element existing in a multimedia framework and a location element of a remote tool server for updating the IPMP tool, the location element being a lower level element of the update element, to register as update information in the memory;
an update controller for sending an update request for the IPMP tool to a remote tool server, in response to the update request for the IPMP tool, as indicated by the location element registered in the memory, comparing an IPMP tool and tool information received from the remote tool server with the existing IPMP tool stored in the memory to check validity, and if the IPMP tool received from the remote tool server is valid, storing the received IPMP tool and tool information in the memory; and
a transceiver for communicating with the remote tool server at an indicated location, under the control of the update controller, to deliver the update request and receive the IPMP tool and tool information in response to the update request.

20. The client apparatus according to claim 19, wherein the update information register is adapted to, if the update element has a scheduled update time element, which has description allowing the IPMP tool to be updated at the predetermined time, parse and register the scheduled update time element as the update information.

21. The client apparatus according to claim 19, wherein the update information register is adapted to, if the update element has a supported platform element defining platform properties and capabilities necessary for supporting the IPMP tool, parse and register the supported platform element as the update information.

22. The client apparatus according to claim 20, wherein the update controller is adapted to, if the update element has a scheduled update time element, judge that updating is necessary at a time designated by the scheduled update time element.

23. The client apparatus according to claim 21, wherein update controller is adapted to, if the update element has a supported platform element, compare the platform properties and capabilities of the client apparatus satisfy conditions designated by the supported platform element, and if the conditions are not satisfied, judge that updating be necessary.
